(19) United States
(12) Patent Application Publication
(10) Pub. No.: US 2016/0042404 A1
(43) Pub. Date: Feb. 11, 2016

(54) EPHEMERAL MESSAGE COMMUNICATION FROM A SENDER TO A RECIPIENT USING A MULTIMEDIA DATA ROUTED THROUGH A SERVER

(71) Applicant: Vellum Tech Corporation, Cupertino, CA (US)

(72) Inventors: Ishwar Joshi, Fremont, CA (US); Chandra Nukala, Cupertino, CA (US)

(21) Appl. No.: 14/495,915

(22) Filed: Sep. 25, 2014

Related U.S. Application Data
(60) Provisional application No. 62/033,106, filed on Aug. 5, 2014.

(51) Int. Cl. G06Q 30/02; H04L 29/06; H04L 12/58

(52) U.S. Cl. CPC G06Q 30/0272; H04L 51/046; H04L 63/10; G06Q 30/0257; G06Q 30/0267; G06Q 30/0261

(57) ABSTRACT

A server device determines a message received from the sender device associated with an ephemeral-messaging client application accessed by the sender device which converts the message received from the sender device into a multimedia data embedded with the message based on a designated using an algorithm of the server device using a processor and a memory. The method determines a recipient device that has requested access to the message and applies a business rule when determining an access privilege of the message associated with the recipient device and a user of the recipient device. The recipient device access to the multimedia data converted from the message based on the business rule and automatically purges the message and the multimedia data from the server device based on the business rule after the multimedia data is communicated to the recipient device.

### CLAIM OF PRIORITY

This application is a non-provisional application and claims priority from the U.S. Provisional Application No. 62/033,106 titled “EPHEMERAL MESSAGE COMMUNICATION FROM A SENDER TO A RECIPIENT USING A MULTIMEDIA DATA ROUTED THROUGH A SERVER” filed on Aug. 5, 2014.

### FIELD OF THE TECHNOLOGY

This disclosure relates generally to the field of communication, and more particularly, to a system, method, and apparatus of ephemeral message communication from a sender to a recipient using a multimedia data routed through a server.

### BACKGROUND

An ephemeral messaging application (e.g., Snapchat®, Confide®) may require that a recipient of an ephemeral message to download a custom application (e.g., from Google® Play, Apple® iTunes) to be able to receive, access and/or view the ephemeral message communicated by a sender. However, a recipient may not be comfortable (e.g., may take up too much space, may create clutter, may introduce an unwanted virus) with downloading the custom application for the specific purpose of viewing the ephemeral message.

The recipient may be more comfortable with a standard electronic mail application (e.g., Google® Gmail®, WhatsApp®). However, the standard electronic mail application may not be able to receive, access, and/or view messages from the ephemeral messaging application.

Therefore, the recipient may never receive the ephemeral message.

### SUMMARY

Disclosed are a method, a device and/or a system of an Ephemeral Message Communication from a Sender to a Recipient Using a Multimedia Data Routed through a Server.

In one aspect, a method includes a server device to determine that a message received from the sender device is associated with an ephemeral-messaging client application accessed by the sender device. The method converts the message received from the sender device into a multimedia data embedded with the message based on a criteria designated by the ephemeral-messaging client application using an algorithm of the server device using a processor and a memory. The method determines that a recipient device that has requested access to the message and applies a business rule when determining an access privilege of the message associated with the recipient device and a user of the recipient device. The method also provides the recipient device access to the multimedia data converted from the message based on the business rule and automatically purges the message and the multimedia data from the server device based on the business rule after the multimedia data is communicated to the recipient device.

The method may permit the ephemeral-messaging client application of the sender device to configure the business rule. The business rule may be a timer-limit rule. The message and/or the multimedia data may automatically purge from the server device when an amount of time defined by a timer associated with the business rule is reached when the recipient device is provided access to the multimedia data.

The business rule may be a count-limit rule. The message and/or the multimedia data may automatically purge from the server device when an access count associated with the business rule is reached when the recipient device is provided access to the multimedia data.

The business rule may be a date-limit rule. The message and/or the multimedia data may automatically purge from the server device when a particular day and/or a time of day of the particular day arrives and the recipient device has not yet requested access to the message.

The business rule may be a geo-spatial rule. The recipient device may deny access to the multimedia data when the recipient device is outside a geospatial area defined by the business rule.

The business rule may be a decay rule. The recipient device may provide access to successive versions of the multimedia data when the recipient device is provided access to the multimedia data. The business rule may be an organization rule. The recipient device may deny access to the multimedia data when the recipient device is not associated with an authorized corporate account defined by the business rule. The business rule may be an advertising rule. An advertisement may be displayed with the multimedia data when the recipient device is provided access to the multimedia data. The advertising rule may display on the recipient device when the recipient device is denied access to the multimedia data. The advertising rule may display on the recipient device when the message and/or the multimedia data is purged from a server but access to the message is still requested by the recipient device.

The successive versions of a multimedia content may be defined by the sender device and the successive versions may be associated with a promotional content and/or a contest defined by an advertiser applying the decay rule. The amount of time associated with the timer-limit rule may be between 5 seconds and 180 seconds and the access count may be limited to one.

The multimedia content may be a lossless compression file, a Graphics Interchange Format (GIF) file and/or a streaming video file. The server device may utilize an email server, a document server, an instant messaging server, an animation server, and/or a streaming server to communicate the multimedia data to the recipient device. The recipient device may use a standard electronic mail website to access the multimedia data having the message.

The multimedia data may automatically execute on the standard electronic mail website upon opening of an electronic mail message based on an in-line Hypertext Markup Language (HTML) script. The in-line HTML script may fetch a non-looping animation file and a non-looping streaming video file from the server device upon viewing of the electronic mail message containing the in-line HTML script. The recipient device may use a custom communication client that automatically deletes communications from the custom communication client of the recipient device associated with the message and/or the multimedia data that has been purged, deleted, and/or expired on the server device.

In another aspect, a method of a server device determines whether a message received from the sender device is associated with an ephemeral-messaging client application accessed by the sender device. The method converts the message received from the sender device into a multimedia data embedded with the message based on a criteria designated by the ephemeral-messaging client application using an algorithm of the server device using a processor and a memory. The method may determine if a recipient device requested access to the message and may apply a business rule when determining an access privilege of the message associated with the recipient device and a user of the recipient device. The method provides the recipient device access to the multimedia data converted from the message based on the business rule. The method also automatically purges the message and the multimedia data from the server device based on the business rule after the multimedia data is communicated to the recipient device. Further the method permits the ephemeral-messaging client application of the sender device to configure the business rule.

The business rule may be a timer-limit rule in the another aspect. The message and the multimedia data may be automatically purged from the server device when an amount of time defined by a timer associated with the business rule is reached when the recipient device is provided access to the multimedia data. The business rule may also a count-limit rule. The message and the multimedia data may be automatically purged from the server device when an access count associated with the business rule is reached when the recipient device is provided access to the multimedia data. The business rule may also a date-limit rule. The message and the multimedia data may be automatically purged from the server device when a particular day and a time of day of the particular day arrive and the recipient device has not yet requested access to the message. The business rule may also a geo-spatial rule. The recipient device may be denied access to the multimedia data when the recipient device is outside a geospatial area defined by the business rule. The business rule may also a decay rule. The recipient device may be provided access to successive versions of the multimedia data when the recipient device is provided access to the multimedia data. The business rule ma be also an organization rule. The recipient device may be denied access to the multimedia data when the recipient device is not associated with an authorized corporate account defined by the business rule. The business rule may also be an advertising rule. An advertisement may be displayed with the multimedia data when the recipient device is provided access to the multimedia data.

In yet another aspect, a system of an ephemeral messaging environment includes a computer server of the ephemeral messaging environment. The computer server including one or more computers having instructions stored thereon that when executed because the one or more computers to determine a message received from a sender device is associated with an ephemeral-messaging client application accessed by the sender device. The computer server may convert the message received from the sender device into a multimedia data embedded with the message based on a criteria designated by the ephemeral-messaging client application using an algorithm of the server device using a processor and a memory. The computer server may determine that a recipient device has requested access to the message. The computer server may apply a business rule when determining an access privilege of the message associated with the recipient devices and a user of the recipient device. The computer server may provide the recipient device access to the multimedia data converted from the message based on the business rule and automatically purge the message and the multimedia data from the server device based on the business rule after the multimedia data is communicated to the recipient device.

The methods, devices, and systems disclosed herein may be implemented in any means for achieving the various aspects, and may be executed in the form of a non-transitory machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE FIGURES

The embodiments of this invention are illustrated by way of example and not imitation in the figures of the accompanying drawings, in which like references indicate similar elements and in which:

FIG. 1A is a network view of a computer server communicatively coupled with a server device to communicate with a recipient device and a sender device through the network using an ephemeral-messaging client application, according to one embodiment.

FIG. 1B is a network view of the computer server communicatively coupled with the server device communicating with a recipient device and a sender device through the network using an ephemeral-messaging client application, according to one embodiment.

FIG. 2A is an exploded view of a business rule algorithm of FIG. 1A including different types of the business rules, according to one embodiment.

FIG. 2B is an exploded view of a business rule algorithm of FIG. 1A illustrating the different types of the business rules, according to one embodiment.

FIG. 2C is an exploded view of a business rule of FIG. 1A illustrating the different types of the business rules, according to one embodiment.

FIG. 2D is an exploded view of a business rule of FIG. 1A including different types of the business rules, according to one embodiment.

FIG. 3 is an exploded view of ephemeral-messaging environment illustrating various components of ephemeral-messaging client application of FIG. 1A, according to one embodiment.

FIG. 4 is a critical path view illustrating a flow based on time in which critical operations in server device of FIG. 1 are established, according to one embodiment.

FIG. 5 is a process flow of ephemeral-messaging client application of FIG. 1A, according to one embodiment.

FIG. 6A is a user interface view of a user experience of the receiver, according to one embodiment.

FIG. 6B is a user interface view of a GIF animation displaying the message and the timer, according to one embodiment.

FIG. 6C is a user interface view of an application sending the message, according to one embodiment.

Other features of the present embodiments will be apparent from the accompanying drawings and from the detailed description that follows.

### DETAILED DESCRIPTION

Example embodiments, as described below, may be used to provide a method, a system and/or an apparatus of an Ephemeral Message Communication from a Sender to a Recipient Using a Multimedia Data Routed through a Server. Although the present embodiments have been described with reference to specific example embodiments, it will be evident that various modifications and changes may be made to these embodiments without departing from the broader spirit and scope of the various embodiments.

In one embodiment, a method includes a server device 102 determines that a message 104 received from the sender device 106 is associated with an ephemeral-messaging client application 108 accessed by the sender device 106. The method converts the message 104 received from the sender device 106 into a multimedia data 110 embedded with the message 104 based on a criteria designated by the ephemeral-messaging client application 108 using an algorithm 112 of the server device 102 using a processor 114 and a memory 116. The method determines a recipient device 122 that has requested access to the message 104 and applies a business rule (e.g., using business rule algorithm 118) (e.g., using business rule (e.g., using business rule algorithm 118) algorithm when determining an access privilege (e.g., using access privilege data 120) of the message 104 associated with the recipient device 122 and a user 124 of the recipient device 122.

The method also provides the recipient device 122 access to the multimedia data 110 converted from the message 104 based on the business rule (e.g., using business rule algorithm 118) and automatically purge (e.g., using purge data 126) the message 104 and the multimedia data 110 from the server device 102 based on the business rule (e.g., using business rule algorithm 118) after the multimedia data 110 is communicated to the recipient device 122, according to one embodiment.

The method may permit the ephemeral-messaging client application 108 of the sender device 106 to configure the business rule (e.g., using business rule algorithm 118). The business rule (e.g., using business rule algorithm 118) may be a timer-limit rule (e.g., using timer-limit rule algorithm 202). The message 104 and/or the multimedia data 110 may automatically purge (e.g., using purge data 126) from the server device 102 when an amount of time (e.g., using amount of time data 216) defined by a timer 218 associated with the business rule (e.g., using business rule algorithm 118) is reached when the recipient device 122 is provided access to the multimedia data 110, according to one embodiment.

The business rule (e.g., using business rule algorithm 118) may be a count-limit rule (e.g., using count-limit rule algorithm 204). The message 104 and/or the multimedia data 110 may automatically purge (e.g., using purge data 126) from the server device 102 when an access count (e.g., using access count data 220) associated with the business rule (e.g., using business rule algorithm 118) is reached when the recipient device 122 is provided access to the multimedia data 110, according to one embodiment.

The business rule (e.g., using business rule algorithm 118) may be a date-limit rule (e.g., using date-limit rule algorithm 206). The message 104 and/or the multimedia data 110 may automatically purge (e.g., using purge data 126) from the server device 102 when a particular day and/or a time of day of the particular day arrives and the recipient device 122 has not yet requested access to the message 104, according to one embodiment.

The business rule (e.g., using business rule algorithm 118) may be a geo-spatial rule (e.g., using geo-spatial rule algorithm 208). The recipient device 122 may deny access to the multimedia data 110 when the recipient device 122 is outside a geospatial area 224 defined by the business rule (e.g., using business rule algorithm 118) , according to one embodiment.

The business rule (e.g., using business rule algorithm 118) may be a decay rule (e.g., using decay rule algorithm 210). The recipient device 122 may provide access to successive versions of the multimedia data 222 when the recipient device 122 is provided access to the multimedia data 110, according to one embodiment. The business rule (e.g., using business rule algorithm 118) may be an organization rule (e.g., using organization rule algorithm 212). The recipient device 122 may deny access to the multimedia data 110 when the recipient device 122 is not associated with an authorized corporate account defined by the business rule (e.g., using business rule algorithm 118) , according to one embodiment.

The business rule (e.g., using business rule algorithm 118) may be an advertising rule (e.g., using advertising rule algorithm 214). An advertisement may be displayed with the multimedia data 110 when the recipient device 122 is provided access to the multimedia data 110. The advertising rule (e.g., using advertising rule algorithm 214) may display on the recipient device 122 when the recipient device 122 is denied access to the multimedia data 110. The advertising rule (e.g., using advertising rule algorithm 214) may display on the recipient device 122 when the message 104 and/or the multimedia data 110 is purge (e.g., using purge data 126)d from a server but access to the message 104 is still requested by the recipient device 122, according to one embodiment.

The successive versions of a multimedia content may be defined by the sender device 106 and the successive versions may be associated with a promotional content and/or a contest defined by an advertiser applying the decay rule (e.g., using decay rule algorithm 210). The amount of time (e.g., using amount of time data 216) associated with the timer-limit rule (e.g., using timer-limit rule algorithm 202) may be between 5 seconds and 180 seconds and the access count (e.g., using access count data 220) may be limited to one, according to one embodiment.

The multimedia content 302 may be a lossless compression file 304, a Graphics Interchange Format (GIF) file 306 and/or a streaming video file 308. The server device 102 may utilize an email server 310, a document server 312, an instant messaging server 314, an animation server 316, and/or a streaming server 318 to communicate the multimedia data 110 to the recipient device 122. The recipient device 122 may use a standard electronic mail website 320 to access the multimedia data 110 having the message 104, according to one embodiment.

The multimedia data 110 may automatically execute on the standard electronic mail website 320 upon opening of an electronic mail message based on an in-line Hypertext Markup Language (HTML) script 322. The in-line HTML script 322 may a non-looping animation file and a non-looping streaming video file 326 from the server device 102 upon viewing of the electronic mail message containing the in-line HTML script 322, according to one embodiment.

The recipient device 122 may use a custom communication client that automatically deletes communications from the custom communication client of the recipient device 122 associated with the message 104 and/or the multimedia data 110 that has been purge (e.g., using purge data 126)d, deleted, and/or expired on the server device 102, according to one embodiment.

In another embodiment, a method of a server device 102 determines a message 104 received from the sender device 106 is associated with an ephemeral-messaging client application 108 accessed by the sender device 106. The method converts the message 104 received from the sender device 106 into a multimedia data 110 embedded with the message 104 based on a criteria designated by the ephemeral-messaging client application 108 using an algorithm of the server device 102 using a processor 114 and a memory 116. The method determines a recipient device 122 requested access to the message 104 and apply a business rule (e.g., using business rule algorithm 118) when determining an access privilege (e.g., using access privilege data 120) of the message 104 associated with the recipient device 122 and a user 124 of the recipient device 122.

The method provides the recipient device 122 access to the multimedia data 110 converted from the message 104 based on the business rule (e.g., using business rule algorithm 118). The method also automatically purge (e.g., using purge data 126)s the message 104 and the multimedia data 110 from the server device 102 based on the business rule (e.g., using business rule algorithm 118) after the multimedia data 110 is communicated to the recipient device 122. Further the method permits the ephemeral-messaging client application 108 of the sender device 106 to configure the business rule (e.g., using business rule algorithm 118) , according to one embodiment.

The business rule (e.g., using business rule algorithm 118) may be a timer-limit rule (e.g., using timer-limit rule algorithm 202). The message 104 and the multimedia data 110 may be automatically purged (e.g., using purge data 126)d from the server device 102 when an amount of time (e.g., using amount of time data 216) defined by a timer 218 associated with the business rule (e.g., using business rule algorithm 118) is reached when the recipient device 122 is provided access to the multimedia data 110. The business rule (e.g., using business rule algorithm 118) may also a count-limit rule (e.g., using count-limit rule algorithm 204). The message 104 and the multimedia data 110 may be automatically purged (e.g., using purge data 126)d from the server device 102 when an access count (e.g., using access count data 220) associated with the business rule (e.g., using business rule algorithm 118) is reached when the recipient device 122 is provided access to the multimedia data 110, according to one embodiment.

The business rule (e.g., using business rule algorithm 118) may also a date-limit rule (e.g., using date-limit rule algorithm 206). The message 104 and the multimedia data 110 may be automatically purged (e.g., using purge data 126) from the server device 102 when a particular day and a time of day of the particular day arrive and the recipient device 122 has not yet requested access to the message 104. The business rule (e.g., using business rule algorithm 118) may also a geo-spatial rule (e.g., using geo-spatial rule algorithm 208). The recipient device 122 may be denied access to the multimedia data 110 when the recipient device 122 is outside a geospatial area 224 defined by the business rule (e.g., using business rule algorithm 118). The business rule (e.g., using business rule algorithm 118) may also be a decay rule (e.g., using decay rule algorithm 210), according to one embodiment.

The recipient device 122 may be provided access to successive versions of the multimedia data 222 when the recipient device 122 is provided access to the multimedia data 110. The business rule (e.g., using business rule algorithm 118) may also an organization rule (e.g., using organization rule algorithm 212). The recipient device 122 may be denied access to the multimedia data 110 when the recipient device 122 is not associated with an authorized corporate account defined by the business rule (e.g., using business rule algorithm 118). The business rule (e.g., using business rule algorithm 118) may also be an advertising rule (e.g., using advertising rule algorithm 214). An advertisement may be displayed with the multimedia data 110 when the recipient device 122 is provided access to the multimedia data 110, according to one embodiment.

In yet another embodiment. a system of an ephemeral messaging environment 300 may include a computer server 100 of the ephemeral messaging environment 300. The computer server 100 may include one or more computers having instructions stored thereon that when executed because the one and/or more computers to determine a message 104 received from a sender device 106 is associated with an ephemeral-messaging client application 108 accessed by the sender device 106. The computer server may convert the message 104 received from the sender device 106 into a multimedia data 110 embedded with the message 104 based on a criteria designated by the ephemeral-messaging client application 108 using an algorithm of the server device 102 using a processor 114 and a memory 116. The computer server may determine that a recipient device 122 has requested access to the message 104. The computer server may apply a business rule (e.g., using business rule algorithm 118) when determining an access privilege (e.g., using access privilege data 120) of the message 104 associated with the recipient device 122s and a user 124 of the recipient device 122. The computer server may provide the recipient device 122 access to the multimedia data 110 converted from the message 104 based on the business rule (e.g., using business rule algorithm 118) and automatically purge (e.g., using purge data 126) the message 104 and the multimedia data 110 from the server device 102 based on the business rule (e.g., using business rule algorithm 118) after the multimedia data 110 is communicated to the recipient device 122.

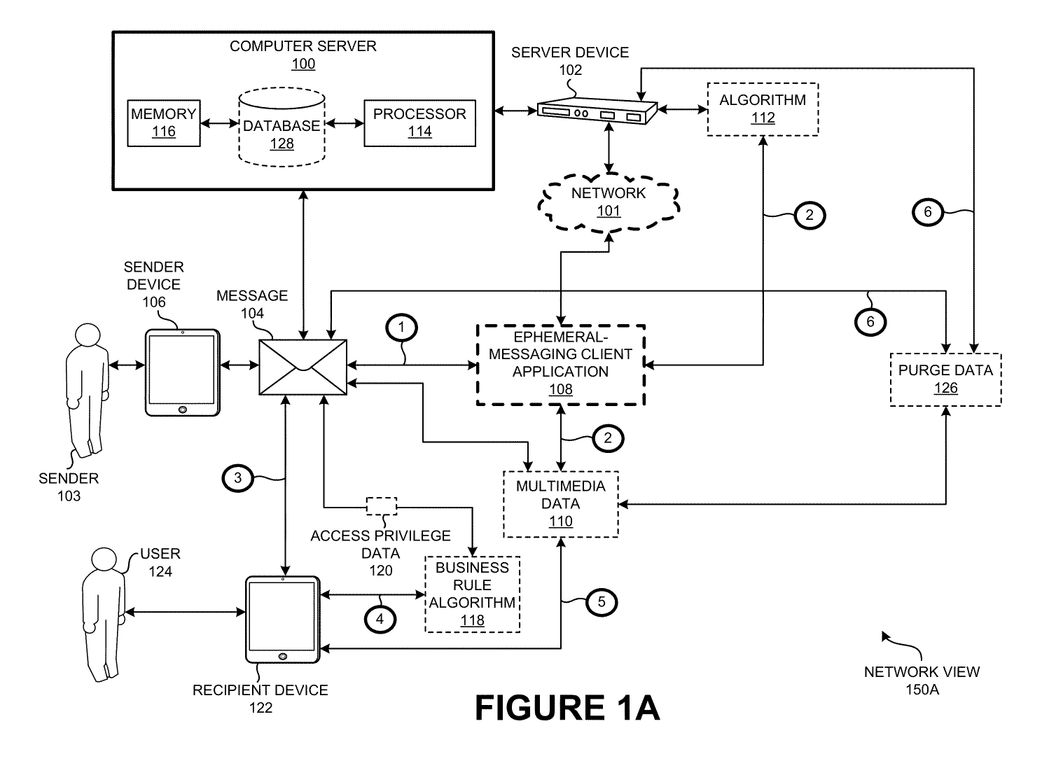

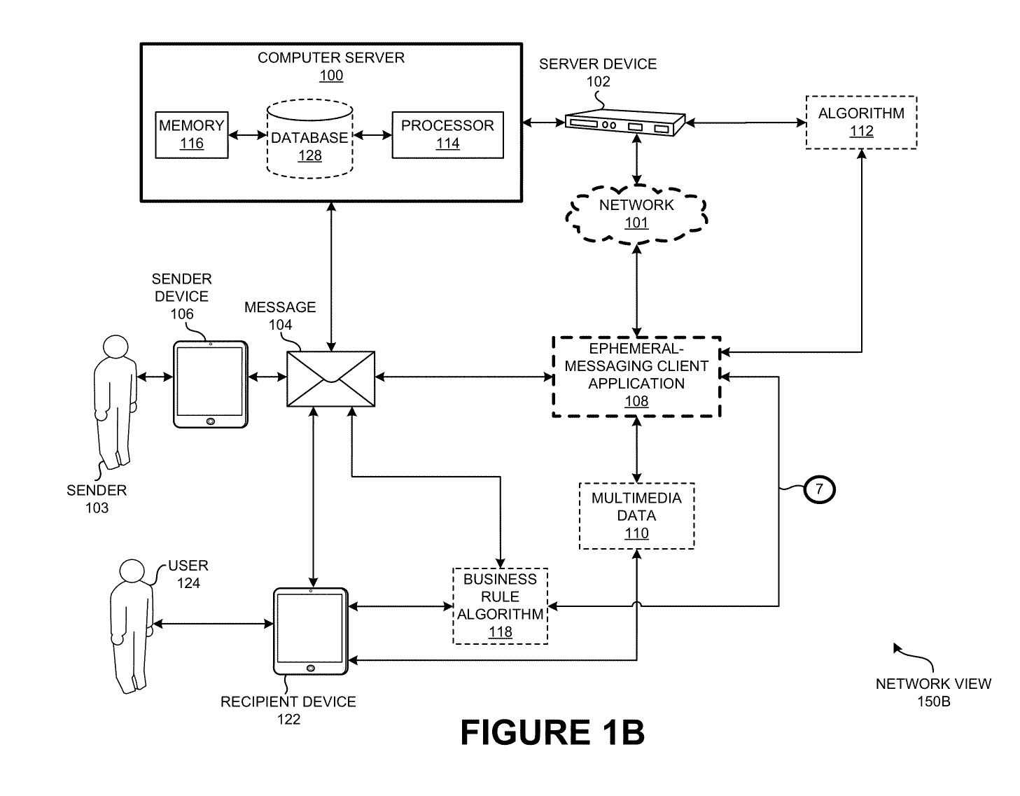

FIG. 1A is a network view of a computer server communicatively coupled with a server device to communicate with a recipient device and a sender device through the network using an ephemeral-messaging client application, according to one embodiment. Particularly, FIG. 1A illustrates, a computer server 100, a network 101, a server device 102, a sender 103, a message 104, a sender device 106, an ephemeral-messaging client application 108, a multimedia data 110, an algorithm 112, a processor 114, a memory, 116, a business rule algorithm 118, an access privilege data 120, a recipient device 122, an user 124, and a purge data 126, according to one embodiment.

A computer server 100 may be a software or a program, running on one or multiple computers, that may manage resources and/or services of the network 101, while handling requests from different computers to access said resources (e.g., a processor and a memory may be communicatively coupled to perform a function). It may be responsible for handling all instructions it receives from hardware and software running on the computer, according to one embodiment. A network 101 may be a group of two or more computer servers (e.g., the computer server 100) linked together. The purpose of the network 101 may be to enable the sharing of files and information between multiple computer servers (e.g., the computer server 100), according to one embodiment.

A server device 102 may be computer hardware and/or software that may receive, store and distribute the message received from the sender device and may be available by the computer server 100 to the user of the recipient device, according to one embodiment. A sender 103 may be a source accessing the ephemeral-messaging client application to send the ephemeral message, according to one embodiment. A message 104 may be a communication from a sender to the user of recipient device using the ephemeral-messaging client application, according to one embodiment.

A sender device 106 may be a dispatcher computer hardware and/or software accessing ephemeral-messaging client application to communicate with the user of the recipient device using the computer server 100, according to one embodiment. An ephemeral-messaging client application 108 may be a software/utility for communication between the sender of sender device and the user of the recipient device. The communication may be expired in a short time which may be set by the sender, according to one embodiment. A multimedia data 110 may be an information that refers to a content that uses a combination of different content forms (e.g., a text, an image, an audio, a video and/or graphics) which can be used by the sender using the ephemeral-messaging client application to communicate with the user of the recipient device, according to one embodiment.

An algorithm 112 may be a set of rules to be used by the ephemeral-messaging client application, according to one embodiment. A processor 114 may be a central processing unit (CPU) within the computer server 100 that carries out the instructions of a computer program by performing the basic arithmetical, logical, and input/output operations, according to one embodiment. A memory 116 may refer to the physical device used to store programs and/or data on a temporary and/or permanent basis for use in a computer and/or other digital electronic device forming the computer server 100, according to one embodiment.

A business rule algorithm 118 may be a set of professional guidelines for the ephemeral-messaging client application, according to one embodiment. An access privilege data 120 may be a right to use the confidential information through the sender server using the ephemeral-messaging client application, according to one embodiment. A recipient device 122 may be a beneficiary's machine receiving the message using the ephemeral-messaging client application, according to one embodiment. An user 124 may be a beneficiary using the recipient device, according to one embodiment. A purge data 126 may be an eradication of statistics from the ephemeral-messaging client application, according to one embodiment.

FIG. 1A illustrates the computer server 100 may be communicatively coupled with the algorithm 112 through the network 101 using the server device 102. The computer server 100 may also be communicatively coupled with the message 104 which may be sent from the sender device 106 of the sender 103 through the network 101. The message 104 may receive from the sender device 106 may be associated with the ephemeral-messaging client application 108. The computer server 100 may include the processor 114, the memory 116 and the database 128, according to one embodiment.

In circle ‘1’, the method may determine that the message 104 may receive from the sender device 106 of FIG. 1A is associated with the ephemeral-messaging client application 108 accessed by the sender device 106. In circle ‘2’, the message 104 may be converted received from the sender device 106 into the multimedia data 110 embedded with the message 104 based on a criteria designated by the ephemeral-messaging client application 108 using the algorithm 112 of the server device 102 using the processor 114 and the memory 116. In circle ‘3’, the method may determine that a recipient device 122 has requested access to the message 104, according to one embodiment.

In circle ‘4’, the business rule (e.g., using the business rule algorithm 118) may be applied when determining the access privilege (e.g., using access privilege data 120) of the message 104 associated with the recipient device 122 and/or the user 124 of the recipient device 122 of FIG. 1A. In circle ‘5’, the recipient device 122 may be provided access to the multimedia data 110 converted from the message 104 based on the business rule (e.g., using business rule algorithm 118). In circle ‘6’, the message 104 and/or the multimedia data 110 from the server device 102 may be automatically purged based on the business rule (e.g., using business rule algorithm 118) after the multimedia data 110 is communicated to the recipient device 122, according to one embodiment.

FIG. 1B is a network view of the computer server communicatively coupled with the server device communicating with a recipient device and a sender device through the network using an ephemeral-messaging client application, according to one embodiment. Particularly FIG. 1B builds on FIG. 1A.

FIG. 1B illustrates the computer server 100 may be communicatively coupled with the ephemeral-messaging client application 108 through the network 101 using the server device 102 of FIG. 1A. In circle ‘6’, the ephemeral-messaging client application 108 of the sender device 106 may be permitted to configure the business rule (e.g., using the business rule algorithm 118), according to one embodiment.

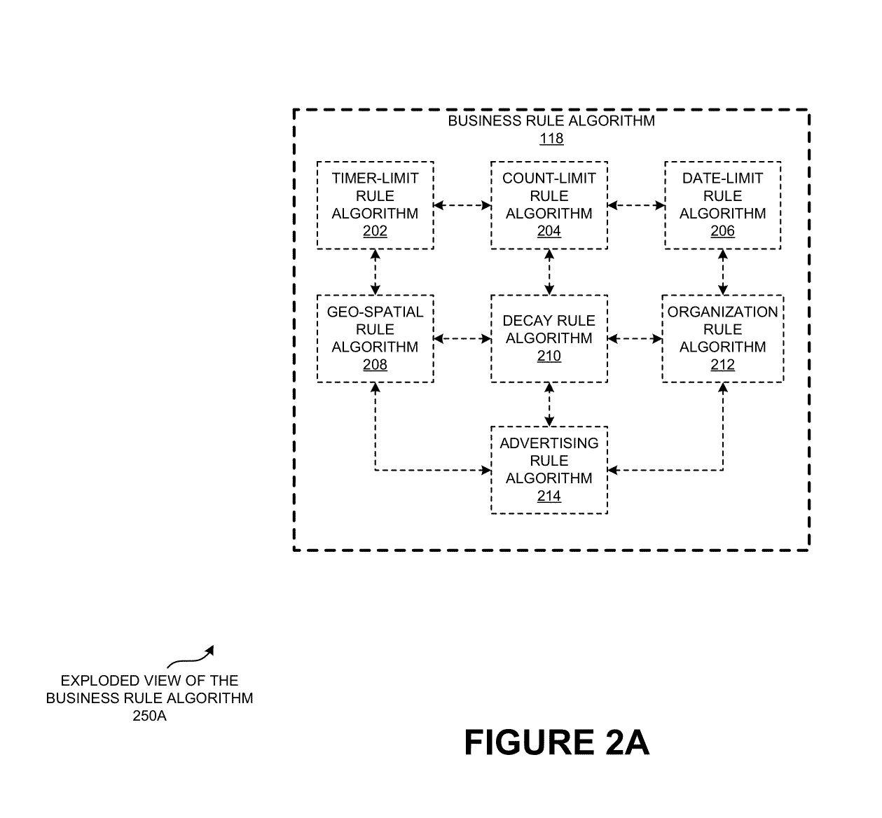

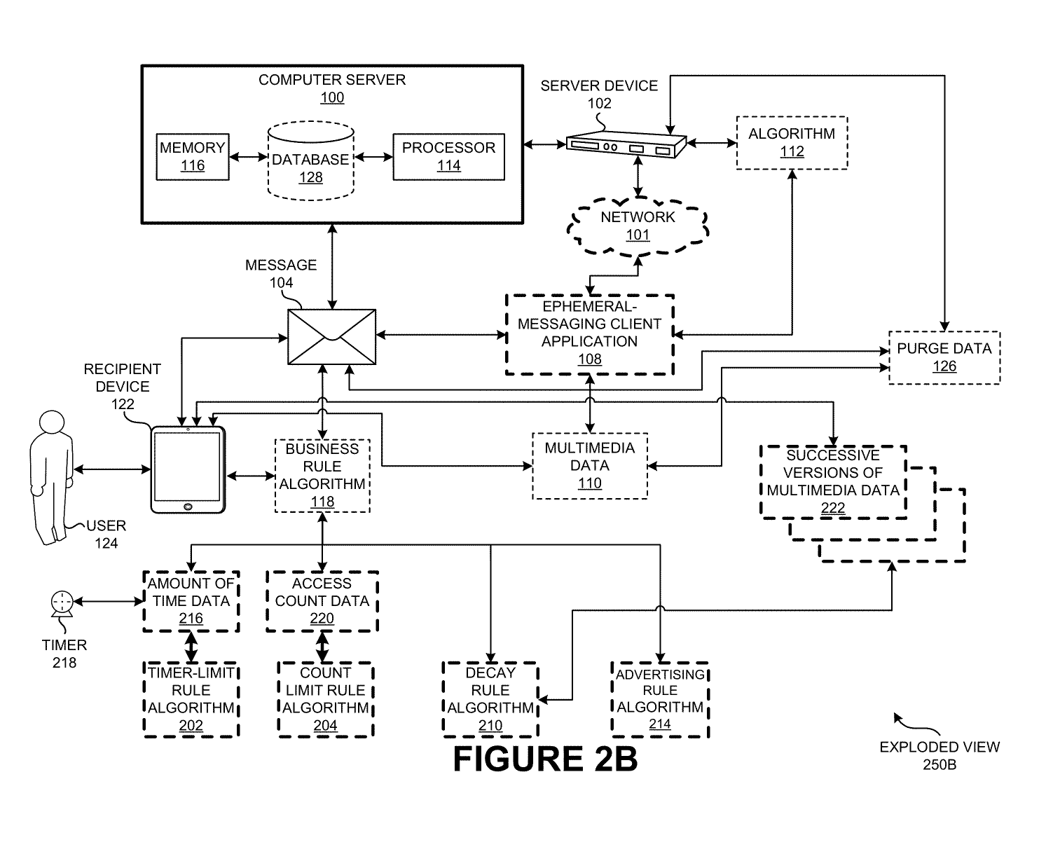

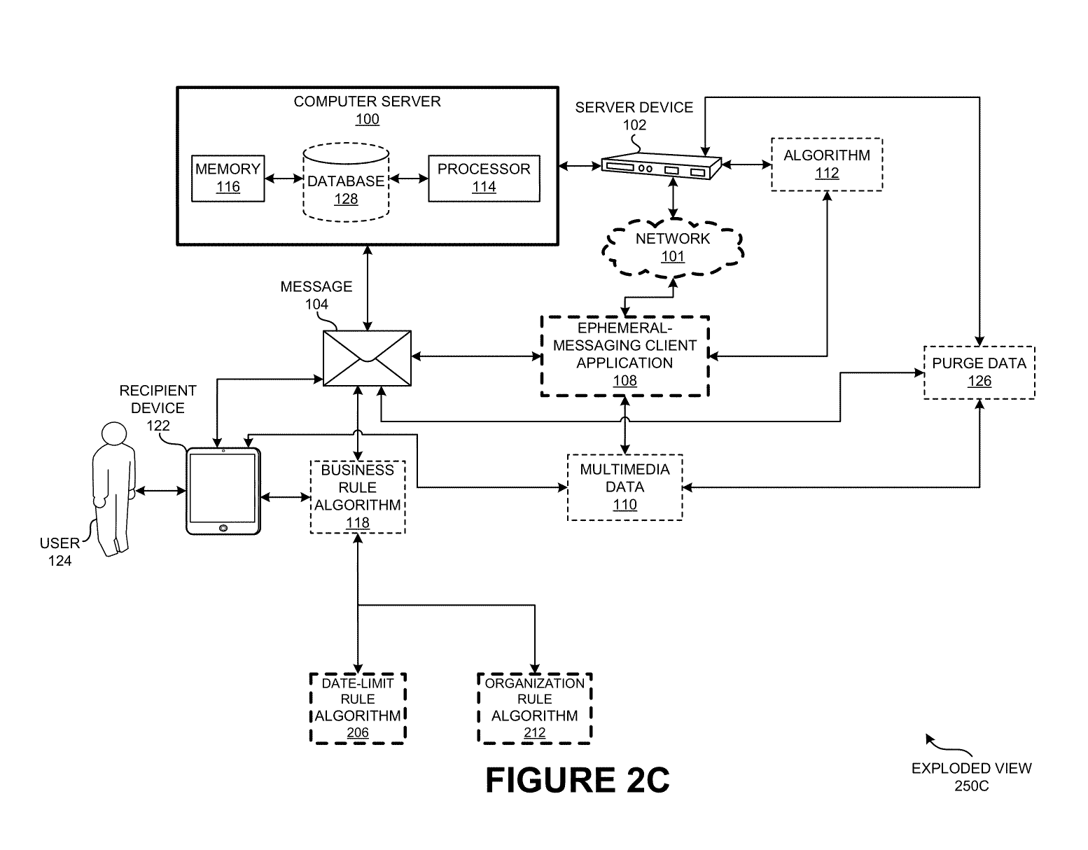

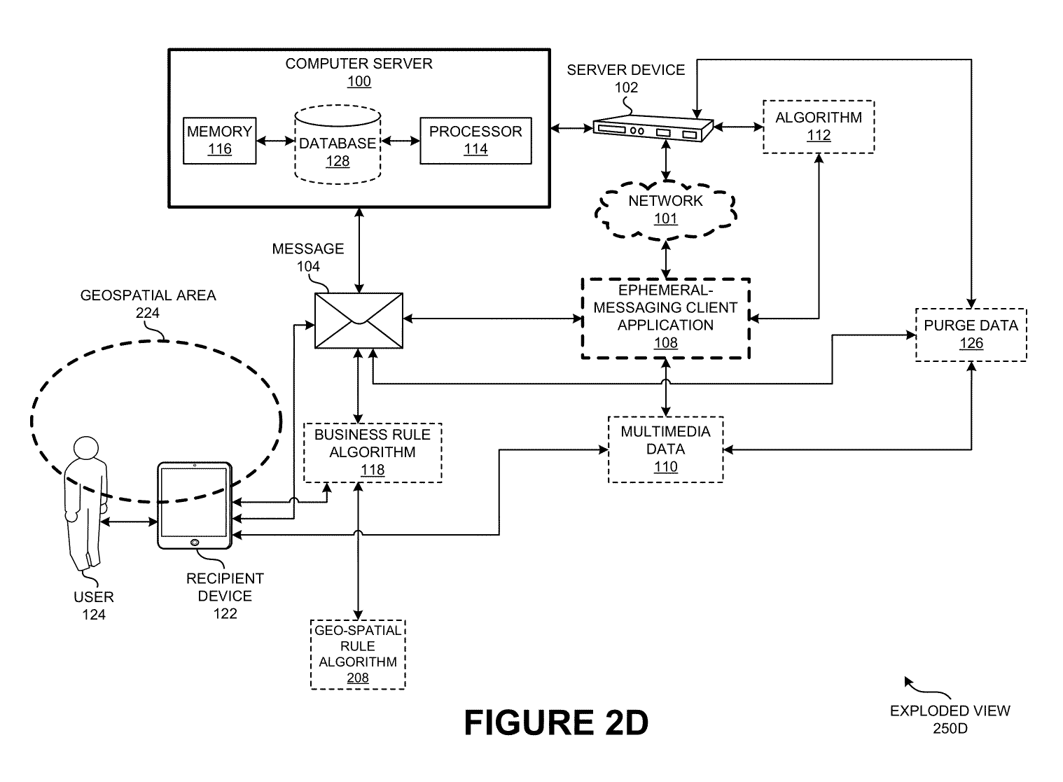

FIG. 2A is an exploded view of a business rule algorithm of FIG. 1A including different types of the business rules, according to one embodiment. Particularly FIG. 2A illustrates a timer-limit rule algorithm 202, a count-limit rule algorithm 204, a date-limit rule algorithm 206, a geo-spatial rule algorithm 208, a decay rule algorithm 210, an organization rule algorithm 212, and an advertising rule algorithm 214, according to one embodiment.

A timer-limit rule algorithm 202 may be the set of rules to automatically purge the message and/or the multimedia data from the server device when an amount of time defined by a timer associated with the business rule is reached when the recipient device is provided access to the multimedia data, according to one embodiment. A count-limit rule algorithm 204 may be the set of rules to automatically purge the message and/or the multimedia data from the server device when an access count associated with the business rule is reached when the recipient device is provided access to the multimedia data, according to one embodiment.

A date-limit rule algorithm 206 may be the set of rules to automatically purge the message and/or the multimedia data from the server device when a particular day and/or a time of day of the particular day arrives and the recipient device has not yet requested access to the message, according to one embodiment. A geo-spatial rule algorithm 208 may be the set of rules to deny access to the multimedia data when the recipient device is outside a geospatial area defined by the business rule, according to one embodiment.

A decay rule algorithm 210 may be the set of rules to access to recipient device to successive versions of the multimedia data when the recipient device is provided access to the multimedia data, according to one embodiment. An organization rule algorithm 212 may be the set of rules to deny to the recipient device to access multimedia data when the recipient device is not associated with an authorized corporate account defined by the business rule, according to one embodiment. An advertising rule algorithm 214 may be the set of rules to display an advertisement with the multimedia data when the recipient device is provided access to the multimedia data, according to one embodiment.

FIG. 2A illustrates the business rule (e.g., using the business rule algorithm 118) of FIG. 1A including algorithms illustrated above may be communicatively coupled with each other. The timer-limit rule algorithm 202 may be coupled with count-limit rule algorithm 204. The count-limit rule algorithm 204 may be coupled with the date-limit rule algorithm 206. The date-limit rule algorithm 206 may be coupled with the organization rule algorithm 212. The organization rule algorithm 212 may be coupled with the advertising rule algorithm 214 and the decay rule algorithm 210. The advertising rule algorithm 214 may be coupled with the geo-spatial rule algorithm 208 and the decay rule algorithm 210. The geo-spatial rule algorithm 208 may be coupled with the decay rule algorithm 210 and the timer-limit rule algorithm 202, according to one embodiment.

FIG. 2B is an exploded view of a business rule algorithm of FIG. 1A illustrating the different types of the business rules, according to one embodiment. Particularly FIG. 2B builds on FIG. 1A and FIG. 2A and further adds an amount of time data 216, a timer 218, an access count data 220, and a successive versions of multimedia data 222, according to one embodiment.

An amount of time data 216 may be the volume of period associated with the timer-limit rule, according to one embodiment. A timer 218 may be a device to control the amount of time set by the sender of the ephemeral message using the ephemeral-messaging client application, according to one embodiment.

An access count data 220 may include records which users are permitted to access information and messages through of the ephemeral-messaging client application, according to one embodiment. A successive versions of multimedia data 222 may be a sequential form of a text, an image, an audio, a video and/or graphics which can be used by the sender using the ephemeral-messaging client application to communicate with the user of the recipient device, according to one embodiment.

FIG. 2B illustrates the computer server 100 may be communicatively coupled with the ephemeral-messaging client application 108 through the network 101 using the server device 102 of FIG. 1A. In the timer-limit rule algorithm 202, the message 104 and/or the multimedia data 110 may be automatically purged (e.g., using purge data 126) from the server device 102 when the amount of time data 216 defined by the timer 218 associated with the business rule (business rule algorithm 118) is reached when the recipient device 122 may be provided access to the multimedia data 110. In the count-limit rule algorithm 204, the message 104 and/or the multimedia data 110 may be automatically purged (e.g., using purge data 126) from the server device 102 when the access count data 220 associated with the business rule (e.g., using business rule algorithm 118) is reached when the recipient device 122 may be provided access to the multimedia data 110, according to one embodiment.

In the decay rule algorithm 210 of FIG. 2A, the ephermal message may disappear after a finite amount of time. In the advertising rule algorithm 214, the advertisement may be displayed with the multimedia data 110 when the recipient device 122 may be provided access to the multimedia data 110. The successive versions of multimedia data 222 may be associated with a promotional content and/or a contest defined by the advertiser applying the decay rule algorithm 210, according to one embodiment.

FIG. 2C is an exploded view of a business rule of FIG. 1A illustrating the different types of the business rules, according to one embodiment. Particularly FIG. 2C builds on FIG. 1A, FIG. 2A and FIG. 2B.

Particularly, FIG. 2C illustrates that the computer server 100 is communicatively coupled with the ephemeral-messaging client application 108 through the network 101 using the server device 102 of FIG. 1A. In the date-limit rule algorithm 206, the message 104 and/or the multimedia data 110 may be automatically purged from the server device 102 when a particular day and/or a time of day of the particular day arrives and the recipient device 122 has not yet requested access to the message 104. In organization rule algorithm 212, the recipient device 122 may be denied access to the multimedia data 110 when the recipient device 122 is not associated with an authorized corporate account defined by the business rule algorithm 118, according to one embodiment.

FIG. 2D is an exploded view of a business rule of FIG. 1A including different types of the business rules, according to one embodiment. Particularly FIG. 2D builds on FIG. 1A, FIG. 2A and FIG. 2B and further adds a geospatial area 224, according to one embodiment. A geospatial area 224 may be a particular location associated with the ephemeral-messaging client application defined by the business rule, according to one embodiment.

FIG. 2D illustrates that the computer server 100 may be communicatively coupled with the ephemeral-messaging client application 108 through the network 101 using the server device 102 of FIG. 1A. In geo-spatial rule algorithm 208, the recipient device 122 may be denied access to the multimedia data 110 when the recipient device is outside the geospatial area 224 defined by the business rule algorithm 118, according to one embodiment.

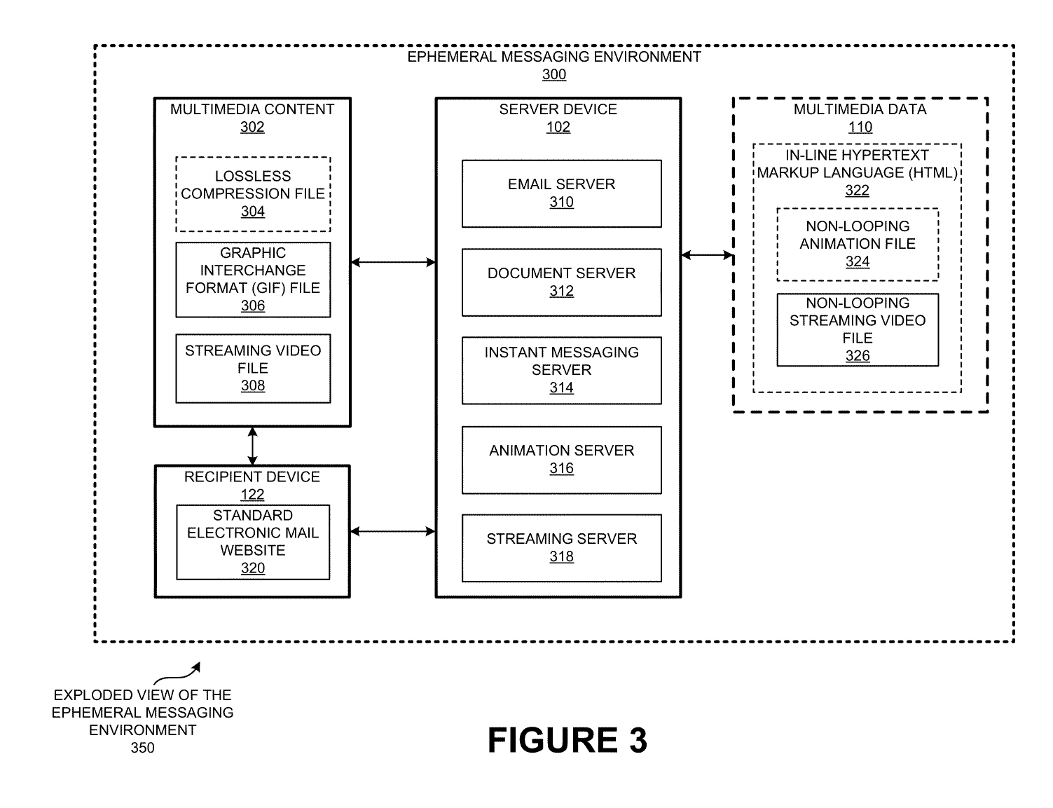

FIG. 3 is an exploded view of ephemeral messaging environment 300 illustrating various components of ephemeral-messaging client application 108 of FIG. 1A, according to one embodiment. Particularly FIG. 3 illustrates, a multimedia content 302, a lossless compression file 304, a graphic interchange format (GIF) 306, a streaming video file 308, an email server 310, a document server 312, an instant messaging server 314, an animation server 316, a streaming server 318, a standard electronic mail website 320, an in-line Hypertext Markup Language (HTML) script 322, a non-looping animation file 324, and a non-looping streaming video file 326, according to one embodiment.

A multimedia content 302 may refer to satisfactory information that uses a combination of different media forms (e.g., a lossless compression file, a Graphics Interchange Format (GIF) file and/or a streaming video file), according to one embodiment. A lossless compression file 304 may be a binder and or a folder of a smaller output from a larger input of data without loss of information eliminating redundancy, according to one embodiment.

A graphic interchange format (GIF) 306 may be a lossless presentation for image files that supports both animated and static images (e.g., a GIF image), according to one embodiment. A streaming video file 308 may be a binder and/or folder of a one-way video transmission over a data network. It may be used to watch video clips and movies (e.g., from the internet on computers, tablets, smartphones and/or TVs), according to one embodiment.

An email server 310 may be a computer and/or computer program with mail transfer agent (MTA) functions. Mail may be exchanged between email servers running special software, which may be built around standardized protocols for handling messages and their varied content (e.g., multimedia content), according to one embodiment. A document server 312 may be a dedicated computer and/ or computer program that may connect a scanner device to the network, enabling users to easily distribute digitized documents over IP-networks, according to one embodiment.

An instant messaging server 314 may refer to the Java Enterprise System Messaging Server product itself, including all components (e.g., server, multiplexor, and Java Enterprise System Instant Messaging Server), according to one embodiment. An animation server 316 may be a computer and/or computer program of creating motion and shape change illusion by means of the rapid display of a sequence of static images that minimally differ from each other, according to one embodiment.

A streaming server 318 may be a computer and/or computer program that may deliver live or on-demand multimedia content to the client devices, according to one embodiment. A standard electronic mail website 320 may be a virtual location for customary transmission of messages over communications networks using World Wide Web (Gmail®, yahoo®, Facebook®, and/or Hotmail®), according to one embodiment. An in-line Hypertext Markup Language (HTML) script 322 may be a categorization of standardized system for tagging text files to achieve font, color, graphic, and hyperlink effects on World Wide Web pages, according to one embodiment.

FIG. 3 illustrates ephemeral messaging environment 300 including the multimedia content 302 may be coupled with the recipient device 122 and the server device 102. The recipient device 122 may be coupled with the server device 102. The server device 102 may be coupled with the multimedia data 110. The multimedia content 302 may include the lossless compression file 304, graphic interchange format (GIF) file 306, and/or the streaming video file 308. The server device 102 may include the email server 310, the document server 312, the instant messaging server 314, the animation server 316 and/or streaming server 318. The recipient device 122 may include the standard electronic mail website 320. The multimedia data 110 may include the in-line Hypertext Markup Language (HTML) script 322. The in-line Hypertext Markup Language (HTML) script 322 may include the non-looping animation file 324 and/or the non-looping streaming video file 326, according to one embodiment.

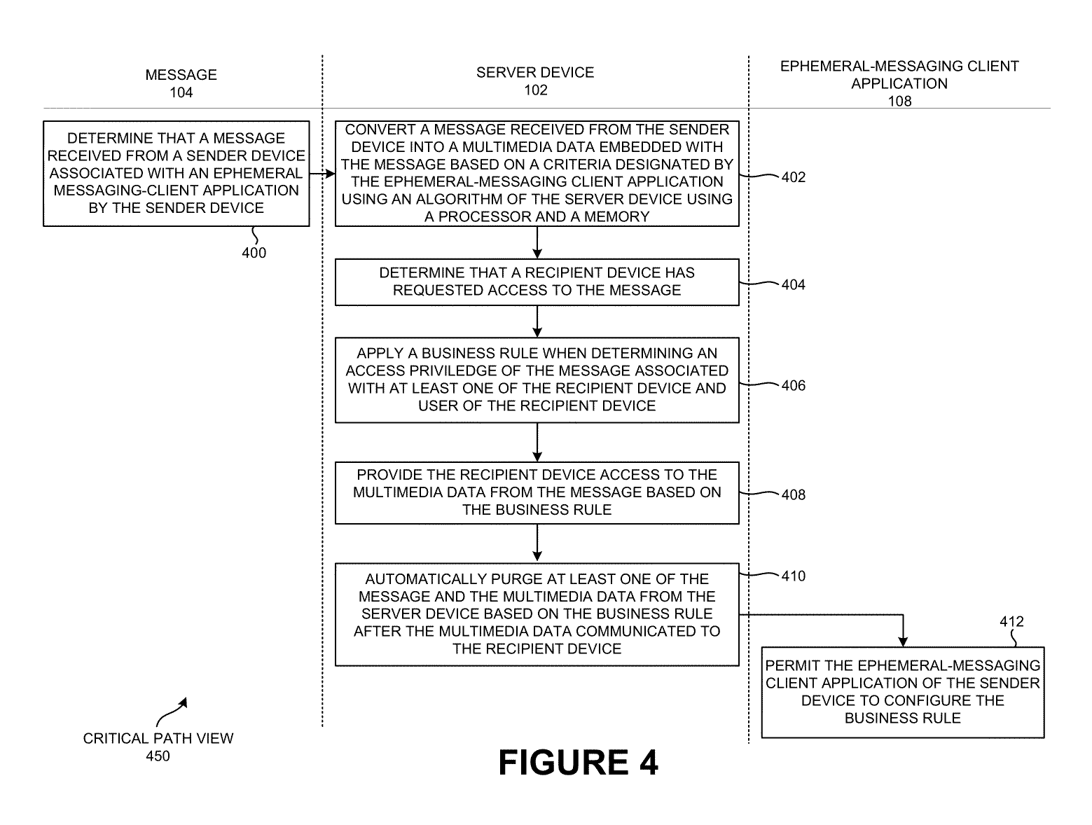

FIG. 4 is a critical path view 450 illustrating a flow based on time in which critical operations in server device 102, a message 104 and an ephemeral-messaging client application 108 of FIG. 1A are established, according to one embodiment. In operation 400, a method may determine that a message 104 received from a sender device 106 is associated with an ephemeral-messaging client application 108 accessed by the sender device 106. In operation 402, the message 104 may be converted received from the sender device 106 into a multimedia data 110 embedded with the message 104 based on a criteria designated by the ephemeral-messaging client application 108 using an algorithm 112 of the server device 102 using a processor 114 and a memory 116. In operation 404, the method may determine that a recipient device 122 has requested access to the message 104, according to one embodiment.

In operation 406, a business rule (e.g., using business rule algorithm 118) may be applied when determining an access privilege of the message 104 associated with the recipient device 122 and/or a user 124 of the recipient device 122. In operation 408, the recipient device 122 may be provided with access to the multimedia data 110 converted from the message 104 based on the business rule (e.g., using business rule algorithm 118). In operation 410, the method may automatically purge (e.g., using purge data 126) the message 104 and/or the multimedia data 110 from the server device 102 based on the business rule (e.g., using business rule algorithm 118) after the multimedia data 110 is communicated to the recipient device 122. In operation 412, the ephemeral-messaging client application 108 of the sender device 106 may permit to configure the business rule (e.g., using business rule algorithm 118), according to one embodiment.

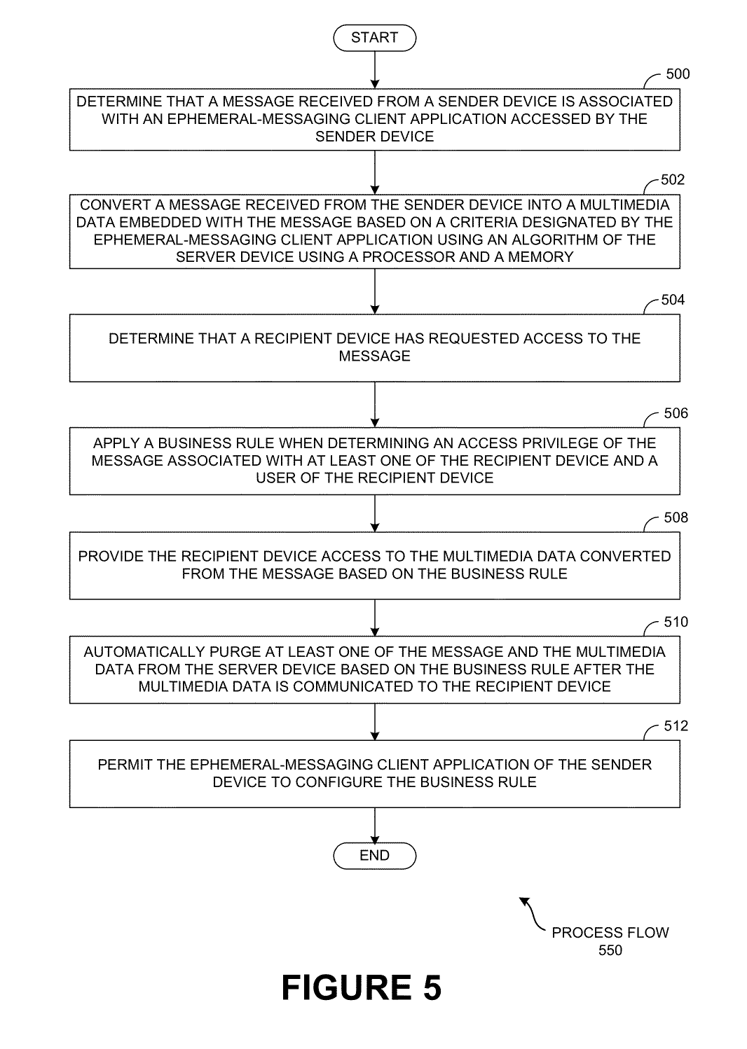

FIG. 5 is a process flow 550 of ephemeral-messaging client application 108 of FIG. 1A, according to one embodiment. In operation 500, a method may determine that a message 104 received from a sender device 106 is associated with an ephemeral-messaging client application 108 accessed by the sender device 106. In operation 502, the message 104 may be converted received from the sender device 106 into a multimedia data 110 embedded with the message 104 based on a criteria designated by the ephemeral-messaging client application 108 using an algorithm 112 of the server device 102 using a processor 114 and a memory 116. In operation 504, the method may determine that a recipient device 122 has requested access to the message 104, according to one embodiment.

In operation 506, a business rule (e.g., using business rule algorithm 118) may be applied when determining an access privilege of the message 104 associated with the recipient device 122 and/or a user 124 of the recipient device 122. In operation 508, the recipient device 122 may be provided with access to the multimedia data 110 converted from the message 104 based on the business rule (e.g., using business rule algorithm 118). In operation 510, the method may automatically purge (e.g., using purge data 126) the message 104 and/or the multimedia data 110 from the server device 102 based on the business rule (e.g., using business rule algorithm 118) after the multimedia data 110 is communicated to the recipient device 122. In operation 512, the ephemeral-messaging client application 108 of the sender device 106 may permit to configure the business rule (e.g., using business rule algorithm 118), according to one embodiment.

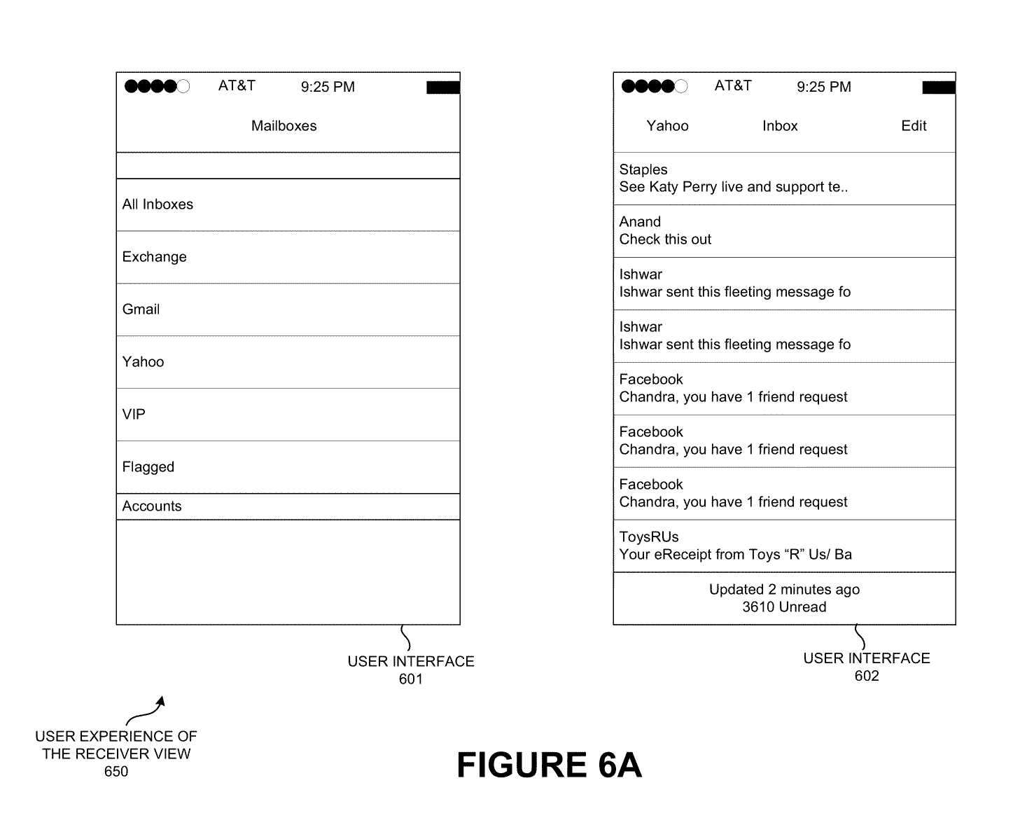

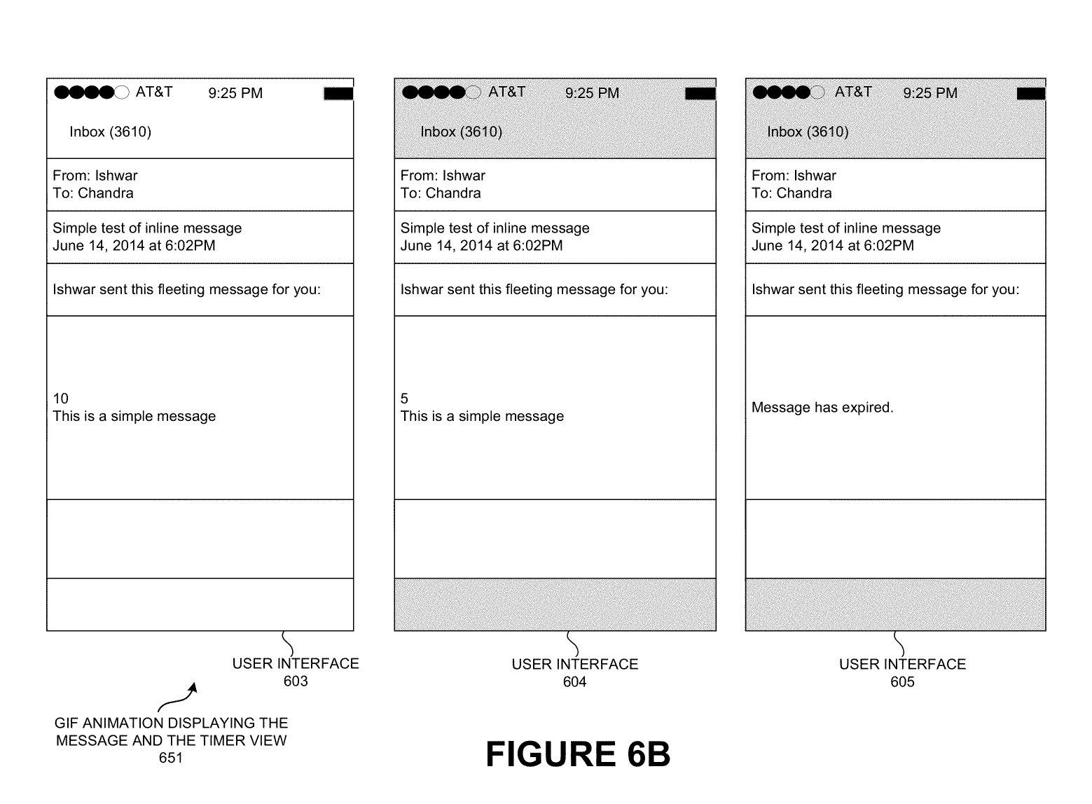

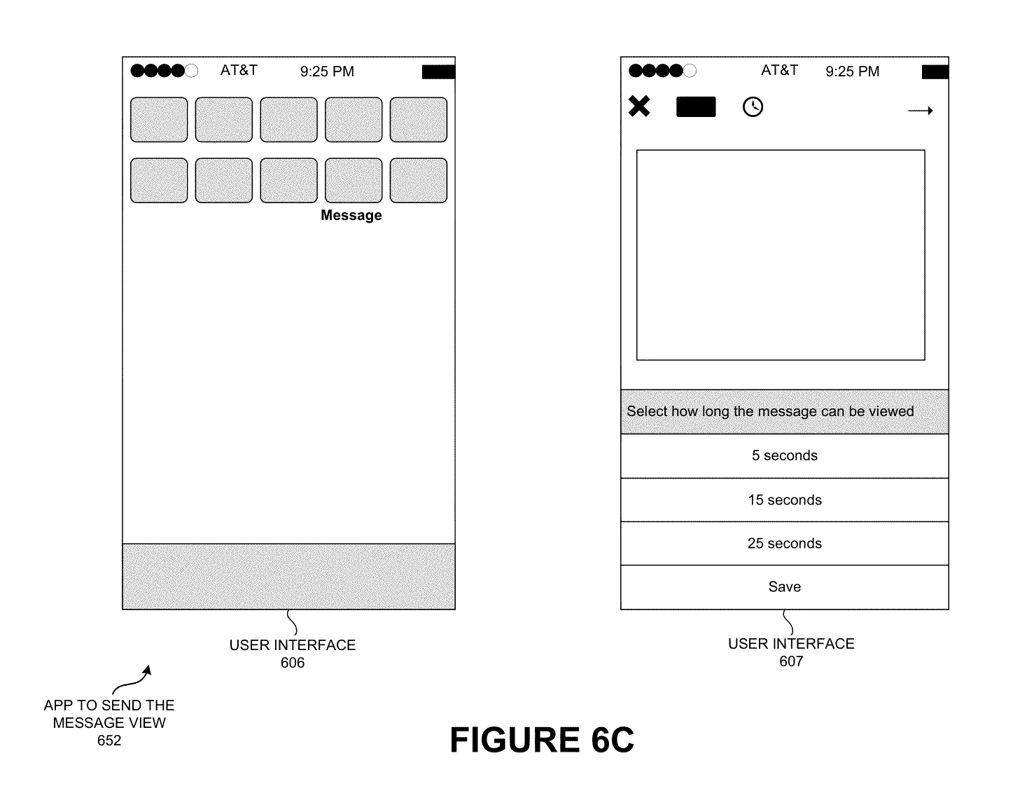

FIG. 6A is a user experience of the receiver view 650, according to one embodiment. Particularly FIG. 6A illustrates a user interface 601 and the user interface 602, according to one embodiment.

The user interface 601 illustrates all inboxes (e.g., Exchange, Gmail, Yahoo, VIP, Flagged accounts) in mailboxes, according to one embodiment. The user interface 602 illustrates the inbox of Yahoo account showing the list of emails received from the different senders. For example, ‘Chandra’ may receive an email from sender ‘Facebook’ showing the subject line ‘Chandra, you have 1 friend request’, according to one embodiment.

FIG. 6B is a GIF animation displaying the message and the timer view 651, according to one embodiment. Particularly FIG. 6B illustrates a user interface 603, the user interface 604 and the user interface 605, according to one embodiment.

The user interface 603 may illustrate the ephemeral message received from the sender to the recipient showing the time limit of the ephemeral message. For example the recipient ‘Chandra’ may receive the message from Ishwar' on Jun. 14, 2014 at 6:02 PM with a tag line Ishwar sent this fleeting message to you:' and this message might be viewable for 10 seconds. The user interface 604 may illustrate the ephemeral message received from the sender to the recipient showing the time limit of the ephemeral message. For example the recipient ‘Chandra’ may receive the message from ‘Ishwar’ on Jun. 14, 2014 at 6:02 PM with a tag line Ishwar sent this fleeting message to you:', and this message might be viewable after 5 seconds. The user interface 605 may illustrate the ephemeral message received from the sender to the recipient showing the interface of expired ephemeral message. For example the recipient ‘Chandra’ might receive the message from ‘Ishwar’ on Jun. 14, 2014 at 6:02 PM with a tag line Ishwar sent this fleeting message to you:' displaying the ‘Message has expired’, according to one embodiment.

FIG. 6C is application to send the message view 652, according to one embodiment. Particularly FIG. 6C illustrates a user interface 606 and the user interface 607.

The user interface 606 may illustrate the ephemeral-messaging client application 108 of the sender device 106 showing the different messages. The user interface 607 may illustrate the ephemeral-messaging client application 108 of the sender device 106. The sender 103 of the sender device 106 may set the time-limit (e.g., ‘Select how long the message can be viewed’ for ‘5 seconds’, ‘15 seconds’ and/or ‘25 seconds’) for the user 124 of recipient device 122. For example the sender ‘Ishwar’ of the sender device 106 may set a time-limit of ‘15 seconds’ that how long the message can be viewed for the user ‘Chandra’ of recipient device 122, according to one embodiment.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. in addition other steps may be provided, or steps may be eliminated, from the described flows, and other components may be added to, or removed from, the described systems. Accordingly, other embodiments are within the scope of the following claims

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A method of a server device comprising:
determining that a message received from a sender device is associated with an ephemeral-messaging client application accessed by the sender device;
converting the message received from the sender device into a multimedia data embedded with the message based on a criteria designated by the ephemeral-messaging client application using an algorithm of the server device using a processor and a memory;
determining that a recipient device has requested access to the message;
applying a business rule when determining an access privilege of the message associated with at least one of the recipient device and a user of the recipient device;
providing the recipient device access to the multimedia data converted from the message based on the business rule; and
automatically purging at least one of the message and the multimedia data from the server device based on the business rule after the multimedia data is communicated to the recipient device.

2. The method of claim 1 further comprising:
permitting the ephemeral-messaging client application of the sender device to configure the business rule, wherein the business rule is at least one of:
a timer-limit rule wherein at least one of the message and the multimedia data is automatically purged from the server device when an amount of time defined by a timer associated with the business rule is reached when the recipient device is provided access to the multimedia data,
a count-limit rule wherein at least one of the message and the multimedia data is automatically purged from the server device when an access count associated with the business rule is reached when the recipient device is provided access to the multimedia data,
a date-limit rule wherein at least one of the message and the multimedia data is automatically purged from the server device when at least one of a particular day and a time of day of the particular day arrives and the recipient device has not yet requested access to the message,
a geo-spatial rule wherein the recipient device is denied access to the multimedia data when the recipient device is outside a geospatial area defined by the business rule,
a decay rule wherein the recipient device is provided access to successive versions of the multimedia data when the recipient device is provided access to the multimedia data,
an organization rule wherein the recipient device is denied access to the multimedia data when the recipient device is not associated with an authorized corporate account defined by the business rule, and
an advertising rule wherein an advertisement is displayed with the multimedia data when the recipient device is provided access to the multimedia data.

3. The method of claim 2:
wherein the advertising rule to display on the recipient device when the recipient device is denied access to the multimedia data.

4. The method of claim 2:
wherein the advertising rule to display on the recipient device when at least one of the message and the multimedia data is purged from a server but access to the message is still requested by the recipient device.

5. The method of claim 2:
wherein the successive versions of a multimedia content are defined by the sender device, and
wherein the successive versions are associated with at least one of a promotional content and a contest defined by an advertiser applying the decay rule.

6. The method of claim 2:
wherein the amount of time associated with the timer-limit rule is between 5 seconds and 180 seconds, and
wherein the access count is limited to one.

7. The method of claim 1 wherein the multimedia content is at least one of a lossless compression file, a Graphics Interchange Format (GIF) file and a streaming video file.

8. The method of claim 1
wherein the server device to utilize at least one of an email server, a document server, an instant messaging server, an animation server, and a streaming server to communicate the multimedia data to the recipient device.

9. The method of claim 1 wherein the recipient device uses a standard electronic mail website to access the multimedia data having the message.

10. The method of claim 9:
wherein the multimedia data is automatically executed on the standard electronic mail website upon opening of an electronic mail message based on an in-line Hypertext Markup Language (HTML) script, and
wherein an in-line HTML script fetches at least one of a non-looping animation file and a non-looping streaming video file from the server device upon viewing of the electronic mail message containing an in-line HTML script.

11. The method of claim 1:
wherein the recipient device uses a custom communication client that automatically deletes communications from the custom communication client of the recipient device associated with at least one of the message and the multimedia data that has been at least one of purged, deleted, and expired on the server device.

12. A method of a server device comprising:
determining that a message received from a sender device is associated with an ephemeral-messaging client application accessed by the sender device;
converting the message received from the sender device into a multimedia data embedded with the message based on a criteria designated by the ephemeral-messaging client application using an algorithm of the server device using a processor and a memory;
determining that a recipient device has requested access to the message;
applying a business rule when determining an access privilege of the message associated with at least one of the recipient device and a user of the recipient device;
providing the recipient device access to the multimedia data converted from the message based on the business rule; and
automatically purging at least one of the message and the multimedia data from the server device based on the business rule after the multimedia data is communicated to the recipient device, and
permitting the ephemeral-messaging client application of the sender device to configure the business rule, wherein the business rule is at least one of:
a timer-limit rule wherein at least one of the message and the multimedia data is automatically purged from the server device when an amount of time defined by a timer associated with the business rule is reached when the recipient device is provided access to the multimedia data,
a count-limit rule wherein at least one of the message and the multimedia data is automatically purged from the server device when an access count associated with the business rule is reached when the recipient device is provided access to the multimedia data,
a date-limit rule wherein at least one of the message and the multimedia data is automatically purged from the server device when at least one of a particular day and a time of day of the particular day arrives and the recipient device has not yet requested access to the message,
a geo-spatial rule wherein the recipient device is denied access to the multimedia data when the recipient device is outside a geospatial area defined by the business rule,
a decay rule wherein the recipient device is provided access to successive versions of the multimedia data when the recipient device is provided access to the multimedia data,
an organization rule wherein the recipient device is denied access to the multimedia data when the recipient device is not associated with an authorized corporate account defined by the business rule, and
an advertising rule wherein an advertisement is displayed with the multimedia data when the recipient device is provided access to the multimedia data.

13. The method of claim 12:
wherein the advertising rule to display on the recipient device when the recipient device is denied access to the multimedia data.

14. The method of claim 12:
wherein the advertising rule to display on the recipient device when at least one of the message and the multimedia data is purged from a server but access to the message is still requested by the recipient device.

15. The method of claim 12:
wherein the successive versions of a multimedia content are defined by the sender device,
wherein the successive versions are associated with at least one of a promotional content and a contest defined by an advertiser applying the decay rule.

16. The method of claim 12:
wherein the multimedia content is at least one of a lossless compression file, a Graphics Interchange Format (GIF) file and a streaming video file,
wherein the server device to utilize at least one of an email server, a document server, an instant messaging server, an animation server, and a streaming server to communicate the multimedia data to the recipient device,
wherein the recipient device uses a standard electronic mail website to access the multimedia data having the message,
wherein the multimedia data is automatically executed on the standard electronic mail website upon opening of an electronic mail message based on an in-line Hypertext Markup Language (HTML) script, and
wherein an in-line HTML script fetches at least one of a non-looping animation file and a non-looping streaming video file from the server device upon viewing of the electronic mail message containing an in-line HTML script.

17. A system of an ephemeral messaging environment comprising:
a computer server of the ephemeral messaging environment:
the computer server including one or more computers having instructions stored thereon that when executed cause the one or more computers:
to determine that a message received from a sender device is associated with an ephemeral-messaging client application accessed by the sender device;
to convert the message received from the sender device into a multimedia data embedded with the message based on a criteria designated by the ephemeral-messaging client application using an algorithm of a server device using a processor and a memory;
to determine that a recipient device has requested access to the message;
to apply a business rule when determining an access privilege of the message associated with at least one of the recipient device and a user of the recipient device;
to provide the recipient device access to the multimedia data converted from the message based on the business rule; and
automatically purge at least one of the message and the multimedia data from the server device based on the business rule after the multimedia data is communicated to the recipient device.

18. The system of the ephemeral messaging environment of claim 17 wherein the computer server including the one or more computers having instructions stored thereon that when executed cause the one or more computers to:
permit the ephemeral-messaging client application of the sender device to configure the business rule, wherein the business rule is at least one of:
a timer-limit rule wherein at least one of the message and the multimedia data is automatically purged from the server device when an amount of time defined by a timer associated with the business rule is reached when the recipient device is provided access to the multimedia data,
a count-limit rule wherein at least one of the message and the multimedia data is automatically purged from the server device when an access count associated with the business rule is reached when the recipient device is provided access to the multimedia data,
a date-limit rule wherein at least one of the message and the multimedia data is automatically purged from the server device when at least one of a particular day and a time of day of the particular day arrives and the recipient device has not yet requested access to the message,
a geo-spatial rule wherein the recipient device is denied access to the multimedia data when the recipient device is outside a geospatial area defined by the business rule,
a decay rule wherein the recipient device is provided access to successive versions of the multimedia data when the recipient device is provided access to the multimedia data,
an organization rule wherein the recipient device is denied access to the multimedia data when the recipient device is not associated with an authorized corporate account defined by the business rule, and
an advertising rule wherein an advertisement is displayed with the multimedia data when the recipient device is provided access to the multimedia data.

19. The system of the ephemeral messaging environment of claim 17:
wherein the advertising rule to display on the recipient device when the recipient device is denied access to the multimedia data.

20. The system of the ephemeral messaging environment of claim 17:
wherein the multimedia content is at least one of a lossless compression file, a Graphics Interchange Format (GIF) file and a streaming video file,
wherein the server device to utilize at least one of an email server, a document server, an instant messaging server, an animation server, and a streaming server to communicate the multimedia data to the recipient device,
wherein the recipient device uses a standard electronic mail website to access the multimedia data having the message,
wherein the multimedia data is automatically executed on the standard electronic mail website upon opening of an electronic mail message based on an in-line Hypertext Markup Language (HTML) script, and
wherein an in-line HTML script fetches at least one of a non-looping animation file and a non-looping streaming video file from the server device upon viewing of the electronic mail message containing an in-line HTML script.
